(19) United States
(12) Patent Application Publication
(10) Pub. No.: US 2020/0320997 A1
(43) Pub. Date: Oct. 8, 2020

(54) AGENT APPARATUS, AGENT APPARATUS CONTROL METHOD, AND STORAGE MEDIUM

(71) Applicant: HONDA MOTOR CO., LTD., Tokyo (JP)

(72) Inventors: Yoshifumi Wagatsuma, Wako-shi (JP); Sawako Furuya, Wako-shi (JP)

(21) Appl. No.: 16/808,413

(22) Filed: Mar. 4, 2020

(30) Foreign Application Priority Data
Mar. 7, 2019 (JP) 2019-041996

(51) Int. Cl. G10L 15/22; G10L 15/30; G10L 15/32; B60K 35/00

(52) U.S. Cl. CPC G10L 15/22; G10L 15/30; H04W 4/40; B60K 35/00; G10L 15/32

(57) ABSTRACT

An agent apparatus includes: a first acquirer configured to acquire voice of a user; a recognizer configured to recognize the voice acquired by the first acquirer; and a plurality of agent functional units, each of the agent function unit being configured to provide services including causing an output unit to output a response on the basis of a recognition result of the recognizer, wherein, when a first agent functional unit included in the plurality of agent functional units is not able to cope with a request included in the voice recognized by the recognizer and another agent functional unit of the plurality of agent functional units is able to cope with the request, the first agent functional unit causes the output unit to output information for recommending the other agent functional unit to the user.

### CROSS-REFERENCE TO RELATED APPLICATION

Priority is claimed on Japanese Patent Application No. 2019-041996, filed Mar. 7, 2019, the content of which is incorporated herein by reference.

### BACKGROUND

### Field of the Invention

The present invention relates to an agent apparatus, an agent apparatus control method, and a storage medium.

### Description of Related Art

A conventional technology related to an agent function of providing information about driving assistance, vehicle control, other applications, and the like at the request of an occupant of a vehicle while conversing with the occupant has been disclosed (Japanese Unexamined Patent Application, First Publication No. 2006-335231).

### SUMMARY

Although a technology of mounting a plurality of agent functions in a single agent apparatus has been put to practical use in recent years, there are cases in which, if an agent function designated by a user cannot respond to a request from the user even when a plurality of agent functions have been mounted, an agent to which the request will be output cannot be determined. As a result, it is impossible to appropriately assist the user.

An object of the present invention devised in view of such circumstances is to provide an agent apparatus, an agent apparatus control method, and a storage medium which can more appropriately assist a user.

An agent apparatus, an agent apparatus control method, and a storage medium according to the present invention employ configurations described below.

(1): An agent apparatus according to an aspect of the present invention is an agent apparatus including: a first acquirer configured to acquire voice of a user; a recognizer configured to recognize the voice acquired by the first acquirer; and a plurality of agent functional units, each of the agent functional unit being configured to provide a service including causing an output unit to output a response on the basis of a recognition result of the recognizer, wherein, when a first agent functional unit included in the plurality of agent functional units is not able to cope with a request included in the voice recognized by the recognizer and another agent functional unit of the plurality of agent functional units is able to cope with the request, the first agent functional unit causes the output unit to output information for recommending the other agent functional unit to the user.

(2): In the aspect of (1), when the first agent functional unit is not able to cope with the request and the other is able to cope with the request, the first agent functional unit provides information representing that the first agent functional unit is not able to cope with the request to the user and causes the output unit to output the information for recommending the other agent functional unit to the user.

(3): In the aspect of (1), the agent apparatus further includes a second acquirer configured to acquire function information of each of the plurality of agent functional unit, wherein the first agent functional unit acquires information on another agent functional unit which is able to cope with the request on the basis of the function information acquired by the second acquirer.

(4): In the aspect of (1), when the first agent functional unit is not able to cope with the request and the request includes a predetermined request, the first agent functional unit does not cause the output unit to output the information for recommending the other agent functional unit to the user.

(5): In the aspect of (4), the predetermined request includes a request for causing the first agent functional unit to execute a specific function.

(6): In the aspect of (5), the specific function includes a function of controlling a moving body in which the plurality of agent functional units are mounted.

(7): An agent apparatus control method according to another aspect of the present invention is an agent apparatus control method, using a computer, including: activating a plurality of agent functional units; recognizing acquired voice of a user and providing services including causing an output unit to output a response on the basis of a recognition result as functions of the activated agent functional units; and when a first agent functional unit included in the plurality of agent functional units is not able to cope with a request included in the recognized voice and another agent functional unit of the plurality of agent functional units is able to cope with the request, causing the output unit to output information for recommending the other agent functional unit to the user.

(8): A storage medium according to another aspect of the present invention is a storage medium storing a program causing a computer to: activate a plurality of agent functional units; recognize acquired voice of a user and provide services including causing an output unit to output a response on the basis of a recognition result as functions of the activated agent functional units; and when a first agent functional unit included in the plurality of agent functional units is not able to cope with a request included in the recognized voice and another agent functional unit of the plurality of agent functional units is able to cope with the request, cause the output unit to output information for recommending the other agent functional unit to the user.

According to the aspects of (1) to (8), it is possible to more appropriately assist a user.

### BRIEF DESCRIPTION OF THE DRAWINGS

FIG. 1 is a configuration diagram of an agent system including an agent apparatus.

FIG. 2 is a diagram illustrating a configuration of an agent apparatus according to a first embodiment and apparatuses mounted in a vehicle.

FIG. 3 is a diagram illustrating an arrangement example of a display/operating device.

FIG. 4 is a diagram illustrating an arrangement example of a speaker unit.

FIG. 5 is a diagram illustrating an example of details of a function DB.

FIG. 6 is a diagram illustrating a configuration of an agent server and a part of the configuration of the agent apparatus according to the first embodiment.

FIG. 7 is a diagram for describing a scene in which an occupant activates an agent.

FIG. 8 is a diagram illustrating an example of an image displayed by a display controller in a scene in which an agent is activated.

FIG. 9 is a diagram for describing a scene in which a response including information representing that an agent cannot cope with has been output.

FIG. 10 is a diagram for describing a scene in which a process of activating an agent is executed.

FIG. 11 is a diagram illustrating an example of an image IM5 displayed by the display controller in a scene in which an utterance including a predetermined request is given.

FIG. 12 is a flowchart illustrating an example of a flow of processes executed by the agent apparatus of the first embodiment.

FIG. 13 is a diagram illustrating a configuration of an agent apparatus according to a second embodiment and apparatuses mounted in a vehicle.

FIG. 14 is a flowchart illustrating an example of a flow of processes executed by the agent apparatus of the second embodiment.

### DESCRIPTION OF EMBODIMENTS

Hereinafter, embodiments of an agent apparatus, an agent apparatus control method, and a storage medium of the present invention will be described with reference to the drawings. An agent apparatus is an apparatus for realizing a part or all of an agent system. As an example of the agent apparatus, an agent apparatus which is mounted in a vehicle (hereinafter, a vehicle M) and includes a plurality of types of agent functions will be described below. The vehicle M is an example of a moving body. In application of the present invention, the agent apparatus need not necessarily include a plurality of types of agent functions. In addition, although the agent apparatus may be a portable terminal device such as a smartphone, the following description is based on the assumption that the agent apparatus includes a plurality of types of agent functions mounted in a vehicle. An agent function is, for example, a function of providing various types of information based on a request (command) included in an utterance of an occupant (an example of a user) of the vehicle M and controlling various apparatuses or mediating network services while conversing with the occupant. A plurality of types of agents may have different functions, processing procedures, controls, output forms, and details. Agent functions may include a function of performing control of an apparatus in a vehicle (e.g., an apparatus with respect to driving control or vehicle body control), and the like.

An agent function is realized, for example, using a natural language processing function (a function of understanding the structure and meaning of text), a conversation management function, a network search function of searching for other apparatuses through a network or searching for a predetermined database of a host apparatus, and the like in addition to a voice recognition function of recognizing voice of an occupant (a function of converting voice into text) in an integrated manner. Some or all of these functions may be realized by artificial intelligence (AI) technology. A part of a configuration for executing these functions (particularly, the voice recognition function and the natural language processing and interpretation function) may be mounted in an agent server (external device) which can communicate with an on-board communication device of the vehicle M or a general-purpose communication device included in the vehicle M. The following description is based on the assumption that a part of the configuration is mounted in the agent server and the agent apparatus and the agent server realize an agent system in cooperation. An entity that provides a service (service entity) caused to virtually appear by the agent apparatus and the agent server in cooperation is referred to as an agent.

<Overall Configuration>

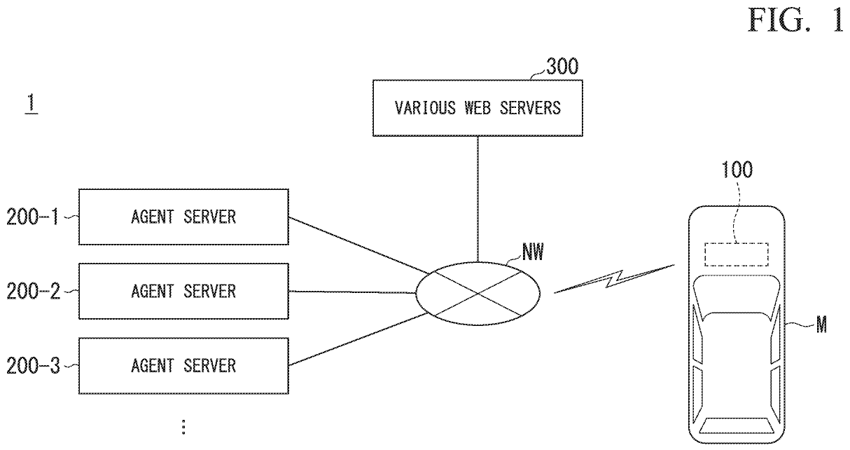

FIG. 1 is a configuration diagram of an agent system 1 including an agent apparatus 100. The agent system 1 includes, for example, the agent apparatus 100 and a plurality of agent servers 200-1, 200-2, 200-3, . . . . Numerals following the hyphens at the ends of reference numerals are identifiers for distinguishing agents. When agent servers are not distinguished, the agent servers may be simply referred to as an agent server 200. Although three agent servers 200 are illustrated in FIG. 1, the number of agent servers 200 may be two, four or more. The agent servers 200 are managed by different agent system providers. Accordingly, agents in the present embodiment are agents realized by different providers. For example, automobile manufacturers, network service providers, electronic commerce subscribers, cellular phone vendors and manufacturers, and the like may be conceived as providers, and any entity (a corporation, an organization, an individual, or the like) may become an agent system provider.

The agent apparatus 100 communicates with the server device 200 via a network NW. The network NW includes, for example, some or all of the Internet, a cellular network, a Wi-Fi network, a wide area network (WAN), a local area network (LAN), a public line, a telephone line, a wireless base station, and the like. Various web servers 300 are connected to the network NW, and the agent server 200 or the agent apparatus 100 can acquire web pages from the various web servers 300 via the network NW.

The agent apparatus 100 makes a conversation with an occupant of the vehicle M, transmits voice from the occupant to the agent server 200 and presents a response acquired from the agent server 200 to the occupant in the form of voice output or image display.

### First Embodiment

### [Vehicle]

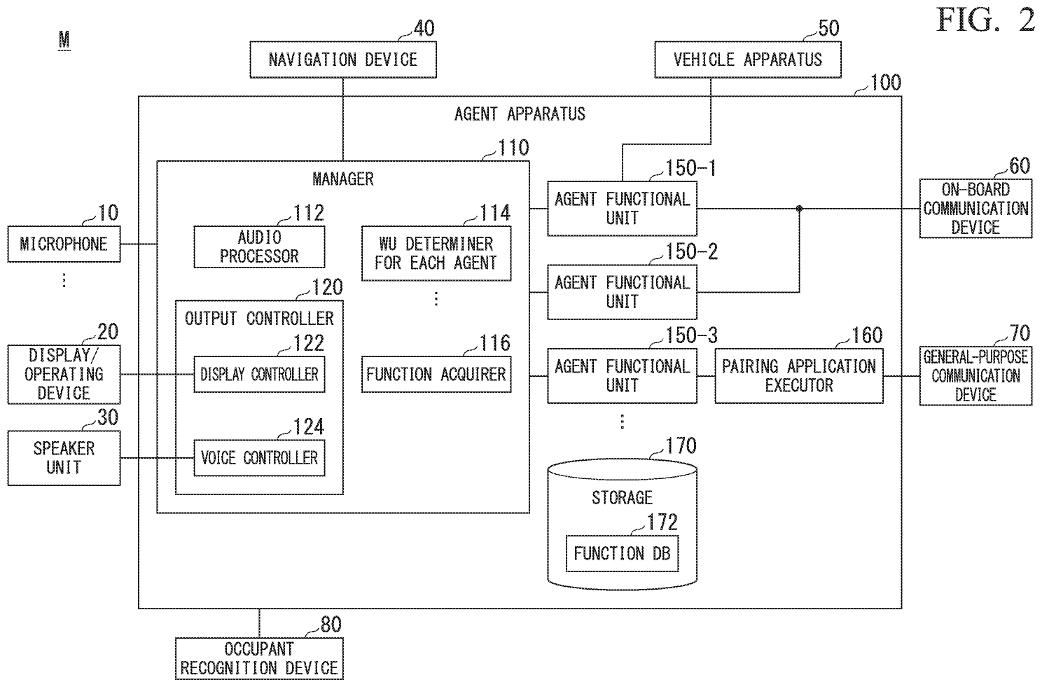

FIG. 2 is a diagram illustrating a configuration of an agent apparatus 100 according to a first embodiment and apparatuses mounted in the vehicle M. For example, one or more microphones 10, a display/operating device 20, a speaker unit 30, a navigation device 40, a vehicle apparatus 50, an on-board communication device 60, an occupant recognition device 80, and the agent apparatus 100 are mounted in the vehicle M. There are cases in which a general-purpose communication device 70 such as a smartphone is included in a vehicle cabin and used as a communication device. Such devices are connected to each other through a multiplex communication line such as a controller area network (CAN) communication line, a serial communication line, a wireless communication network, or the like. The components illustrated in FIG. 2 are merely an example and some of the components may be omitted or other components may be further added. At least one of the display/operating device 20 and the speaker unit 30 is an example of an “output unit.”

The microphone 10 is an audio collector for collecting voice generated in the vehicle cabin. The display/operating device 20 is a device (or a group of devices) which can display images and receive an input operation. The display/operating device 20 includes, for example, a display device configured as a touch panel. Further, the display/operating device 20 may include a head up display (HUD) or a mechanical input device. The speaker unit 30 includes, for example, a plurality of speakers (voice output units) provided at different positions in the vehicle cabin. The display/operating device 20 may be shared by the agent apparatus 100 and the navigation device 40. This will be described in detail later.

The navigation device 40 includes a positioning device such as a navigation human machine interface (HMI) or a global positioning system (GPS), a storage device which stores map information, and a control device (navigation controller) which performs route search and the like. Some or all of the microphone 10, the display/operating device 20, and the speaker unit 30 may be used as an HMI. The navigation device 40 searches for a route (navigation route) for moving to a destination input by an occupant from a position of the vehicle M identified by the positioning device and outputs guide information using the navigation HMI such that the vehicle M can travel along the route. The route search function may be included in a navigation server accessible through the network NW. In this case, the navigation device 40 acquires a route from the navigation server and outputs guide information. The agent apparatus 100 may be constructed on the basis of the navigation controller. In this case, the navigation controller and the agent apparatus 100 are integrated in hardware.

The vehicle apparatus 50 includes, for example, a driving power output device such as an engine and a motor for traveling, an engine starting motor, a door lock device, a door opening/closing device, windows, a window opening/closing device, window opening/closing control device, seats, a seat position control device, a room mirror, a room mirror angle and position control device, illumination devices inside and outside the vehicle, illumination device control devices, wipers, a defogger, wiper and defogger control devices, winkers, a winker control device, an air-conditioning device, devices with respect to vehicle information such as information on a mileage and a tire pressure and information on the quantity of remaining fuel, and the like.

The on-board communication device 60 is, for example, a wireless communication device which can access the network NW using a cellular network or a Wi-Fi network.

The occupant recognition device 80 includes, for example, a seating sensor, an in-vehicle camera, an image recognition device, and the like. The seating sensor includes a pressure sensor provided under a seat, a tension sensor attached to a seat belt, and the like. The in-vehicle camera is a charge coupled device (CCD) camera or a complementary metal oxide semiconductor (CMOS) camera provided in a vehicle cabin. The image recognition device analyzes an image of the in-vehicle camera and recognizes presence or absence, a face orientation, and the like of an occupant for each seat.

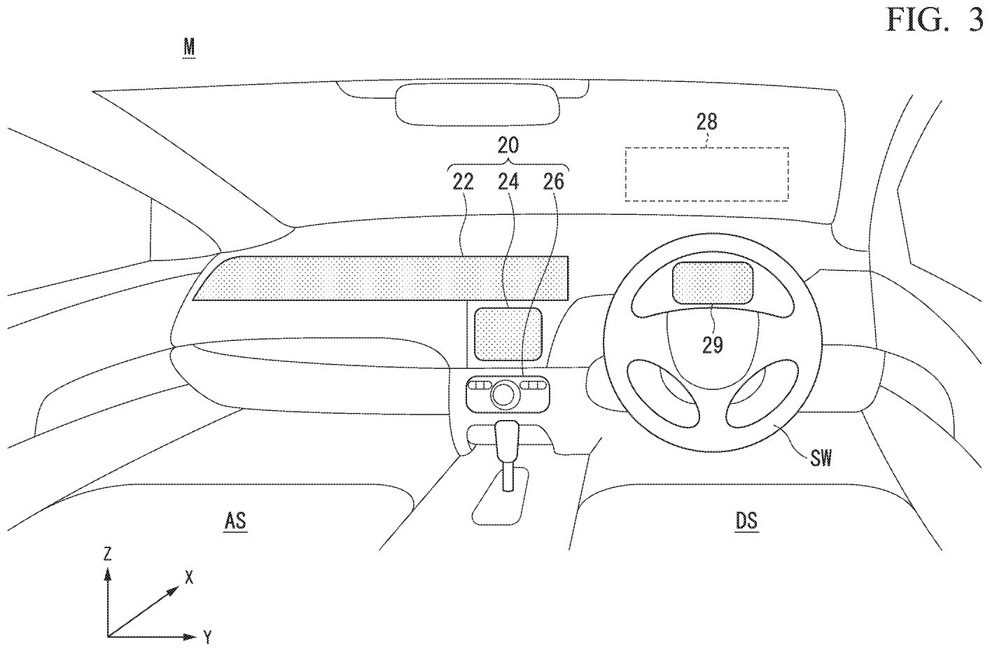

FIG. 3 is a diagram illustrating an arrangement example of the display/operating device 20. The display/operating device 20 may include a first display 22, a second display 24, and an operating switch ASSY 26, for example. The display/operating device 20 may further include an HUD 28. Furthermore, the display/operating device 20 may include a meter display 29 provided at a part of an instrument panel which faces a driver's seat DS. A combination of the first display 22, the second display 24, the HUD 28, and the meter display 29 is an example of an “display.”

The vehicle M includes, for example, the driver's seat DS in which a steering wheel SW is provided, and a passenger seat AS provided in a vehicle width direction (Y direction in the figure) with respect to the driver's seat DS. The first display 22 is a laterally elongated display device extending from the vicinity of the middle of the instrument panel between the driver's seat DS and the passenger seat AS to a position facing the left end of the passenger seat AS. The second display 24 is provided in the vicinity of the middle region between the driver's seat DS and the passenger seat AS in the vehicle width direction under the first display. For example, both the first display 22 and the second display 24 are configured as touch panels and include a liquid crystal display (LCD), an organic electroluminescence (organic EL) display, a plasma display, or the like as a display. The operation switch ASSY 26 is an assembly of dial switches, button type switches, and the like. The HUD 28 is, for example, a device that causes an image overlaid on a landscape to be viewed and causes an occupant to view a virtual image by projecting light including an image to, for example, a front windshield or a combiner of the vehicle M. The meter display 29 is, for example, an LCD, an organic EL, or the like and displays meters such as a speedometer, a tachometer, and the like. The display/operating device 20 outputs details of an operation performed by an occupant to the agent apparatus 100. Details displayed by each of the above-described displays may be determined by the agent apparatus 100.

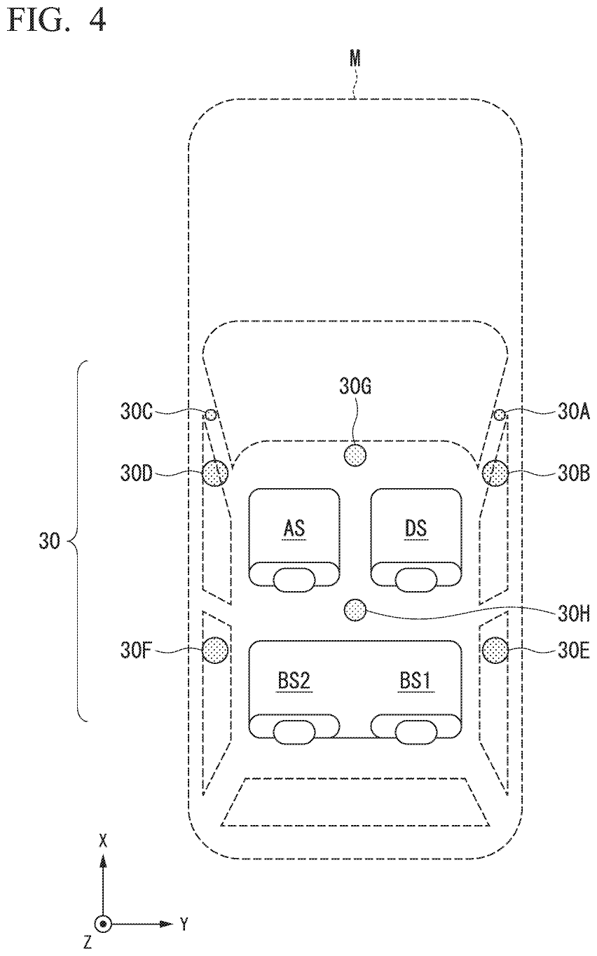

FIG. 4 is a diagram illustrating an arrangement example of the speaker unit 30. The speaker unit 30 includes, for example, speakers 30A to 30H. The speaker 30A is provided on a window pillar (so-called A pillar) on the side of the driver's seat DS. The speaker 30B is provided on the lower part of the door near the driver's seat DS. The speaker 30C is provided on a window pillar on the side of the passenger seat AS. The speaker 30D is provided on the lower part of the door near the passenger seat AS. The speaker 30E is provided on the lower part of the door near the right rear seat BS1. The speaker 30F is provided on the lower part of the door near the left rear seat BS2. The speaker 30G is provided in the vicinity of the second display 24. The speaker 30H is provided on the ceiling (roof) of the vehicle cabin.

In such an arrangement, a sound image is located near the driver's seat DS, for example, when only the speakers 30A and 30B are caused to output sound. “Locating a sound image” is, for example, to determine a spatial position of a sound source perceived by the occupant by controlling the magnitude or timing of sound transmitted to the left and right ears of the occupant. When only the speakers 30C and 30D are caused to output sound, a sound image is located near the passenger seat AS. When only the speaker 30E is caused to output sound, a sound image is located near the front part of the vehicle cabin. When only the speaker 30F is caused to output sound, a sound image is located near the upper part of the vehicle cabin. When only the speaker 30G is caused to output sound, a sound image is located near the front part of the vehicle cabin. When only the speaker 30H is caused to output sound, a sound image is located near the upper part of the vehicle cabin. The present invention is not limited thereto and the speaker unit 30 can locate a sound image at any position in the vehicle cabin by controlling distribution of sound output from each speaker using a mixer and an amplifier.

### [Agent Apparatus]

Referring back to FIG. 2, the agent apparatus 100 includes a manager 110, agent functional units 150-1, 150-2 and 150-3, a pairing application executer 160, and a storage 170. The manager 110 includes, for example, an audio processor 112, a wake-up (WU) determiner 114 for each agent, a function acquirer 116, and an output controller 120. Hereinafter, when the agent functional units are not distinguished, they are simply referred to as an agent functional unit 150. Illustration of three agent functional units 150 is merely an example in which they correspond to the number of the agent servers 200 in FIG. 1 and the number of agent functional units 150 may be two, four or more. Software arrangement in FIG. 2 is illustrated in a simplified manner for description and can be arbitrarily modified, for example, such that the manager 110 may be interposed between the agent functional unit 150 and the on-board communication device 60 in practice. There are cases below in which an agent that is caused to appear by the agent functional unit 150-1 and the agent server 200-1 in cooperation is referred to as “agent 1,” an agent that is caused to appear by the agent functional unit 150-2 and the agent server 200-2 in cooperation is referred to as “agent 2,” and an agent that is caused to appear by the agent functional unit 150-3 and the agent server 200-3 in cooperation is referred to as “agent 3.”

Each component of the agent apparatus 100 is realized, for example, by a hardware processor such as a central processing unit (CPU) executing a program (software). Some or all of these components may be realized by hardware (a circuit including circuitry) such as a large scale integration (LSI) circuit, an application specific integrated circuit (ASIC), a field-programmable gate array (FPGA) or a graphics processing unit (GPU) or realized by software and hardware in cooperation. The program may be stored in advance in a storage device (storage device including a non-transitory storage medium) such as a hard disk drive (HDD) or a flash memory or stored in a separable storage medium (non-transitory storage medium) such as a DVD or a CD-ROM and installed when the storage medium is inserted into a drive device. A combination of the microphone 10 and the audio processor 112 is an example of a “first acquirer.” The function acquirer 116 in the first embodiment is an example of a “second acquirer.”

The storage 170 is realized by the aforementioned various storage devices. For example, data such as a function DB 172 and programs are stored in the storage 170. The function DB 172 will be described in detail later.

The manager 110 functions according to execution of an operating system (OS) or a program such as middleware.

The audio processor 112 of the manager 110 receives collected sound from the microphone 10 and performs audio processing on the received sound such that the sound becomes a state in which it is suitable to recognize a wake-up word preset for each agent. A wake-up word is, for example, a word, a phrase, or the like for activating a target agent. Audio processing is, for example, noise removal, sound amplification, and the like according to filtering using a bandpass filter and the like. The audio processor 112 outputs voice on which audio processing has been performed to the WU determiner 114 for agent and an activated agent functional unit.

The WU determiner 114 for each agent is present corresponding to each of the agent functional units 150-1, 150-2 and 150-3 and recognizes a wake-up word predetermined for each agent. The WU determiner 114 for each agent recognizes, from voice on which audio processing has been performed (voice stream), the meaning of the voice. First, the WU determiner 114 for each agent detects a voice section on the basis of amplitudes and zero crossing of voice waveforms in the voice stream. The WU determiner 114 for each agent may perform section detection based on voice recognition and non-voice recognition in units of frames based on Gaussian mixture model (GMM).

Subsequently, the WU determiner 114 for each agent converts the voice in the detected voice section into text to obtain text information. Then, the WU determiner 114 for each agent determines whether the text information corresponds to a wake-up word. When it is determined that the text information corresponds to a wake-up word, the WU determiner 114 for each agent activates a corresponding agent functional unit 150. The function corresponding to the WU determiner 114 for each agent may be mounted in the agent server 200. In this case, the manager 110 transmits the voice stream on which audio processing has been performed by the audio processor 112 to the agent server 200, and when the agent server 200 determines that the voice stream is a wake-up word, the agent functional unit 150 is activated according to an instruction from the agent server 200. Each agent functional unit 150 may be constantly activated and perform determination of a wake-up word by itself. In this case, the manager 110 need not include the WU determiner 114 for each agent.

When the WU determiner 114 for each agent recognizes an end word included in speech and an agent corresponding to the end word is in an activated state (hereinafter referred to as “activated” as necessary), the WU determiner 114 for each agent ends (stops) an activated agent functional unit in the same procedure as the above-described procedure. Although activation and end of an agent may be performed, for example, by receiving a predetermined operation from the display/operating device 20, an example of activation and stop using voice will be described below. An activated agent may be stopped when voice input is not received for a predetermined time or longer.

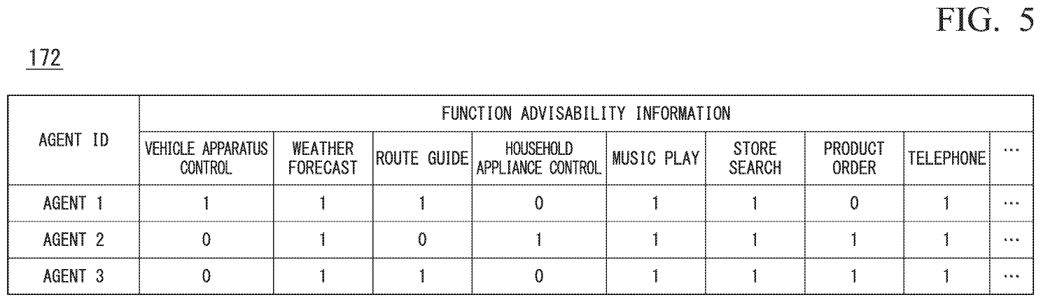

The function acquirer 116 acquires information about functions executable by the agents 1 to 3 mounted in the vehicle M (hereinafter referred to as function information) and stores the acquired function information in the storage 170 as the function database (DB) 172. FIG. 5 is a diagram illustrating an example of details of the function DB 172. In the function DB 172, for example, an agent ID that is identification information for identifying an agent is associated with function advisability information. The function advisability information includes information that represents whether a function associated with a function type is executable and is associated with each agent. Although vehicle apparatus control, weather forecast, route guide, household appliance control, music play, store search, product order, and telephone (hands-free call) are represented as function types in the example of FIG. 5, the number and types of functions are not limited thereto. Although “1” is stored for a function that can be executed by an agent and “0” is stored for a function that cannot be executed in FIG. 5, other information that can identify whether a function is executable may be used.

The function acquirer 116 inquires of each of the agent functional units 150-1 to 150-3 about whether it can execute each of the aforementioned function at a predetermined timing or a predetermined interval and stores function information acquired as inquiry results in the function DB 172. The predetermined timing is, for example, a timing at which software of a mounted agent is upgraded, a timing at which a new agent is added, an agent is deleted, or agents are temporarily stopped for system maintenance, or a timing at which an instruction for executing a process according to the function acquirer 116 is received from the display/operating device 20 or an external device of the vehicle M. When information about function information is received from the agent functional unit 150, the function acquirer 116 updates the function DB 172 on the basis of the received information without performing the aforementioned inquiry. Update includes new registration, change, deletion, and the like of function information.

The function acquirer 116 may acquire the function DB 172 generated in an external device (for example, a database server, a server, or the like) with which communication can be performed through the on-board communication device 60 or the like.

The output controller 120 provides a service or the like to an occupant by outputting information such as a response result to a display or the speaker unit 30 according to an instruction from the manager 110 or the agent functional unit 150. The output controller 120 includes, for example, a display controller 122 and a voice controller 124.

The display controller 122 displays an image in a predetermined area of a display according to an instruction from the output controller 120. The first display 22 is caused to display an image with respect to an agent in the following description. The display controller 122 generates, for example, an image of a personified agent (hereinafter referred to as an agent image) that communicates with an occupant in the vehicle cabin and causes the first display 22 to display the generated agent image according to control of the output controller 120. The agent image is, for example, an image in the form of speaking to the occupant. The agent image may include, for example, a face image from which at least an observer (occupant) can recognize an expression or a face orientation. For example, the agent image may have parts imitating eyes and a nose at the center of the face region such that an expression or a face orientation is recognized on the basis of the positions of the parts at the center of the face region. The agent image may be three-dimensionally perceived such that the face orientation of the agent is recognized by including a head image in the three-dimensional space by the observer or may include an image of a main body (body, hands and legs) such that an action, a behavior, a posture, and the like of the agent can be recognized. The agent image may be an animation image. For example, the display controller 122 may cause the agent image to be displayed at a display region near the position of the occupant recognized by the occupant recognition device 80 or generate an agent image including a face facing the position of the occupant and cause the agent image to be displayed.

The voice controller 124 causes some or all speakers included in the speaker unit 30 to output voice according to an instruction from the output controller 120. The voice controller 124 may perform control of locating a sound image of agent voice at a position corresponding to a display position of an agent image using a plurality of speaker units 30. The position corresponding to the display position of the agent image is, for example, a position predicted to be perceived by the occupant as a position at which the agent image is talking in the agent voice, and specifically, is a position near the display position of the agent image (for example, within 2 to 3 [cm]).

The agent functional unit 150 causes an agent to appear in cooperation with the agent server 200 corresponding thereto to provide a service including a response using voice according to an utterance of the occupant of the vehicle. The agent functional unit 150 may include one authorized to control the vehicle M (for example, vehicle apparatus 50). The agent functional unit 150 may include one that cooperates with the general-purpose communication device 70 via the pairing application executer 160 and communicates with the agent server 200. For example, the agent functional unit 150-1 is authorized to control the vehicle M (for example, vehicle apparatus 50). The agent functional unit 150-1 communicates with the agent server 200-1 via the on-board communication device 60. The agent functional unit 150-2 communicates with the agent server 200-2 via the on-board communication device 60. The agent functional unit 150-3 cooperates with the general-purpose communication device 70 via the pairing application executer 160 and communicates with the agent server 200-3.

The pairing application executer 160 performs pairing with the general-purpose communication device 70 according to Bluetooth (registered trademark), for example, and connects the agent functional unit 150-3 to the general-purpose communication device 70. The agent functional unit 150-3 may be connected to the general-purpose communication device 70 according to wired communication using a universal serial bus (USB) or the like.

When an inquiry about whether each function is executable is received from the function acquirer 116 for each function, the agent functional units 150-1 to 150-3 generate a response (function information) to the inquiry through the agent server 200 or the like and outputs the generated response to the function acquirer 116. Each of the agent functional units 150-1 to 150-3 may transmit function information to the function acquirer 116 when update or the like of the agent function thereof is performed irrespective of an inquiry from the function acquirer 116. Each of the agent functional units 150-1 to 150-3 executes a process on an utterance (voice) of the occupant input from the audio processor 112 or the like and outputs an execution result (for example, a response result for a request included in the utterance) to the manager 110. Agent functions executed by the agent functional unit 150 and the agent server 200 will be described in detail later.

### [Agent Server]

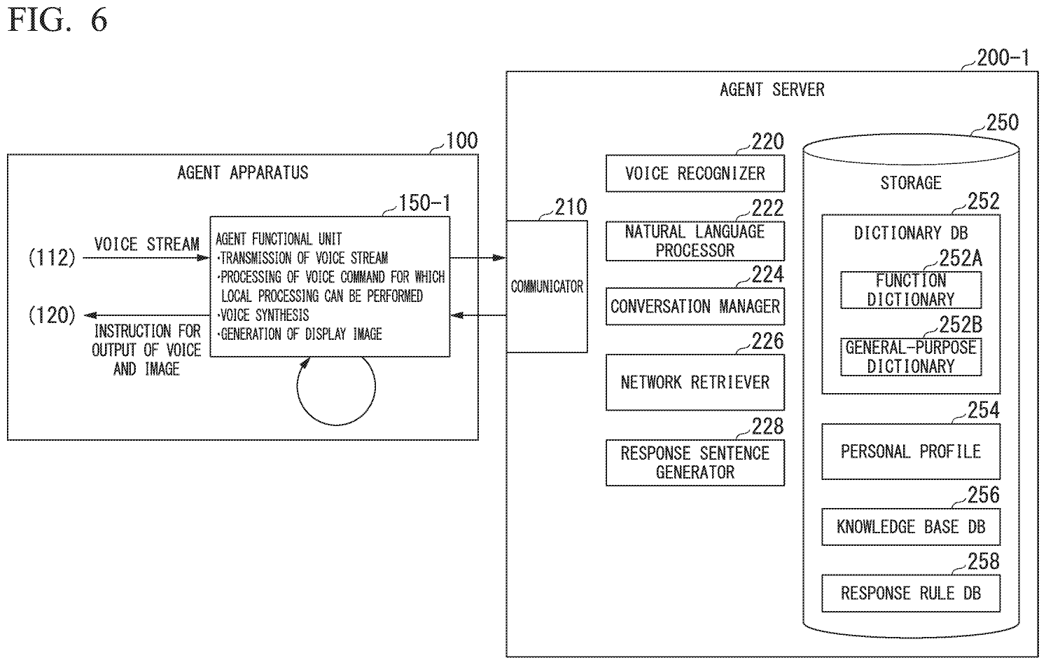

FIG. 6 is a diagram illustrating parts of the configuration of the agent server 200 and the configuration of the agent apparatus 100 according to the first embodiment. Hereinafter, the configuration of the agent server 200 and operations of the agent functional unit 150, and the like will be described. Here, description of physical communication from the agent apparatus 100 to the network NW will be omitted. Although the agent functional unit 150-1 and the agent server 200-1 will be mainly described below, processes will be executed through an almost similar flow with respect to sets of other agent functional units and agent servers even though they have different executable functions, databases, and the like.

The agent server 200-1 includes a communicator 210-1. The communicator 210-1 is, for example, a network interface such as a network interface card (NIC). Further, the agent server 200-1 includes, for example, a voice recognizer 220, a natural language processor 222, a conversation manager 224, a network retriever 226, a response sentence generator 228, and a storage 250. These components are realized, for example, by a hardware processor such as a CPU executing a program (software). Some or all of these components may be realized by hardware (a circuit including circuitry) such as an LSI circuit, an ASIC, an FPGA or a GPU or realized by software and hardware in cooperation. The program may be stored in advance in a storage device (a storage device including a non-transitory storage medium) such as an HDD or a flash memory or stored in a separable storage medium (a non-transitory storage medium) such as a DVD or a CD-ROM and installed when the storage medium is inserted into a drive device. A combination of the voice recognizer 220 and the natural language processor 222 is an example of a “recognizer.”

The storage 250 is realized by the above-described various storage devices. For example, data such as a dictionary DB 252, a personal profile 254, a knowledge base DB 256, and a response rule DB 258 and programs are stored in the storage 250.

In the agent apparatus 100, the agent functional unit 150-1 transmits a voice stream or a voice stream on which processing such as compression or encoding has been performed, input from the audio processor 112 or the like, to the agent server 200-1. When a command (request) which can cause local processing (processing performed without the agent server 200-1) to be performed is recognized, the agent functional unit 150-1 may perform processing requested through the command. The command which can cause local processing to be performed is a command to which a reply can be given by referring to the storage 170 included in the agent apparatus 100. More specifically, the command which can cause local processing to be performed may be, for example, a command for retrieving the name of a specific person from telephone directory data (not shown) present in the storage 170 and calling a telephone number associated with a matching name (calling the other party). Accordingly, the agent functional unit 150-1 may include some functions of the agent server 200-1.

When the voice stream is acquired, the voice recognizer 220 performs voice recognition and outputs text information and the natural language processor 222 performs semantic interpretation on the text information with reference to the dictionary DB 252. The dictionary DB 252 is, for example, a DB in which abstracted semantic information is associated with text information. The dictionary DB 252 includes, for example, a function dictionary 252A and a general-purpose dictionary 252B. The function dictionary 252A is a dictionary for covering functions provided by agent 1 realized by the agent server 200-1 and the agent functional unit 150-1 in cooperation. For example, when agent 1 provides a function of controlling an on-board air-conditioner, words such as “air-conditioner,” “air conditioning,” “turn on,” “turn off,” “temperature,” “increase,” “decrease,” “inside air,” and “outside air” are associated with word types such as verbs and objects and abstracted meanings and registered in the function dictionary 252A. The function dictionary 252A may include information on links between words that can be simultaneously used. The general-purpose dictionary 252B is a dictionary that is not limited to the functions provided by agent 1 and is associated with abstracted meanings of general objects. The function dictionary 252A and the general-purpose dictionary 252B may include information on a list of synonyms. The function dictionary 252A and the general-purpose dictionary 252B may be prepared to correspond to each of a plurality of languages. In this case, the voice recognizer 220 and the natural language processor 222 use the function dictionary 252A, the general-purpose dictionary 252B, and grammar information (not shown) according to language settings set in advance. Steps of processing of the voice recognizer 220 and steps of processing of the natural language processor 222 are not clearly separated from each other and may affect each other in such a manner that the voice recognizer 220 receives a processing result of the natural language processor 222 and corrects a recognition result.

The natural language processor 222 acquires information about a function necessary to cope with a request included in speech (hereinafter referred to as a necessary function) as a semantic analysis based on a recognition result of the voice recognizer 220. For example, when the meaning of “the air-conditioner in the house should be turned on” is recognized as a recognition result, the natural language processor 222 acquires the function type of “household appliance control” as a necessary function with reference to the dictionary DB 252 or the like. Then, the natural language processor 222 outputs the acquired necessary function to the agent functional unit 150-1 and acquires a result of determination of whether the necessary function is executable. When the necessary function is executable, the natural language processor 222 assumes that it is possible to cope with the request and generates a command included in the recognized meaning.

When a meaning such as “Today's weather” or “How is the weather today?” is recognized as a recognition result and a function corresponding to the recognized meaning is executable, for example, the natural language processor 222 generates a command replacing standard text information of “today's weather”. Accordingly, even when a request voice includes variations in text, it is possible to easily make a conversation suitable for the request. The natural language processor 222 may recognize the meaning of text information using artificial intelligence processing such as machine learning processing using probabilities and generate a command based on a recognition result, for example.

The conversation manager 224 determines response details (for example, details of an utterance for the occupant, an image output from the output unit, and speech) for the occupant of the vehicle M with reference to the personal profile 254, the knowledge base DB 256 and the response rule DB 258 on the basis of an input command. The personal profile 254 includes personal information, preferences, past conversation histories, and the like of occupants stored for each occupant. The knowledge base DB 256 is information defining relationships between objects. The response rule DB 258 is information defining operations (replies, details of apparatus control, or the like) that need to be performed by agents for commands.

The conversation manager 224 may identify an occupant by collating the personal profile 254 with feature information acquired from a voice stream. In this case, personal information is associated with the voice feature information in the personal profile 254, for example. The voice feature information is, for example, information about features of a talking manner such as a voice pitch, intonation and rhythm (tone pattern), and feature quantities according to mel frequency cepstrum coefficients and the like. The voice feature information is, for example, information obtained by causing the occupant to utter a predetermined word, sentence, or the like when the occupant is initially registered and recognizing the speech.

The conversation manager 224 causes the network retriever 226 to perform retrieval when the command is for requesting information that can be retrieved through the network NW. The network retriever 226 access the various web servers 300 via the network NW and acquires desired information. “Information that can be retrieved through the network NW” may be evaluation results of general users of a restaurant near the vehicle M or a weather forecast corresponding to the position of the vehicle M on that day, for example.

The response sentence generator 228 generates a response sentence and transmits the generated response sentence (response details) to the agent apparatus 100 such that details of the utterance determined by the conversation manager 224 are delivered to the occupant of the vehicle M. The response sentence generator 228 may acquire a recognition result obtained by the occupant recognition device 80 from the agent apparatus 100, and when the occupant who makes the utterance including the command is identified as an occupant registered in the personal profile 254 according to the acquired recognition result, generate a response sentence for calling the name of the occupant or in a speaking manner similar to the speaking manner of the occupant. When a function included in necessary functions is not executable, the response sentence generator 228 generates a response sentence for delivering the fact that it is impossible to cope with a request to the occupant, generates a response sentence for recommending another agent, or generates a response sentence representing that an executable agent is undergoing maintenance.

When the agent functional unit 150 acquires the response sentence, the agent functional unit 150 instructs the voice controller 124 to perform voice synthesis and output speech. The agent functional unit 150 generates an agent image suited to voice output and instructs the display controller 122 to display the generated agent image, as an image included in response details. In this manner, an agent function in which an agent that has virtually appeared replies to the occupant of the vehicle M is realized.

### [Functions of Agents]

Hereinafter, functions of agents according to the agent functional unit 150 and the agent server 200 will be described in detail. Although the agent functional unit 150-1 from among the plurality of agent functional units 150-1 to 150-3 included in the agent apparatus 100 will be described as a “first agent functional unit” below, the agent functional unit 150-2 or the agent functional unit 150-3 may be the “first agent functional unit.” The “first agent functional unit” is an agent functional unit selected by the occupant (hereinafter, an occupant P) of the vehicle M. “Selecting by the occupant P” is, for example, activating (calling) using a wake-up word included in an utterance of the occupant P. A specific example of response details provided to the occupant P through agent functions will also be described below.

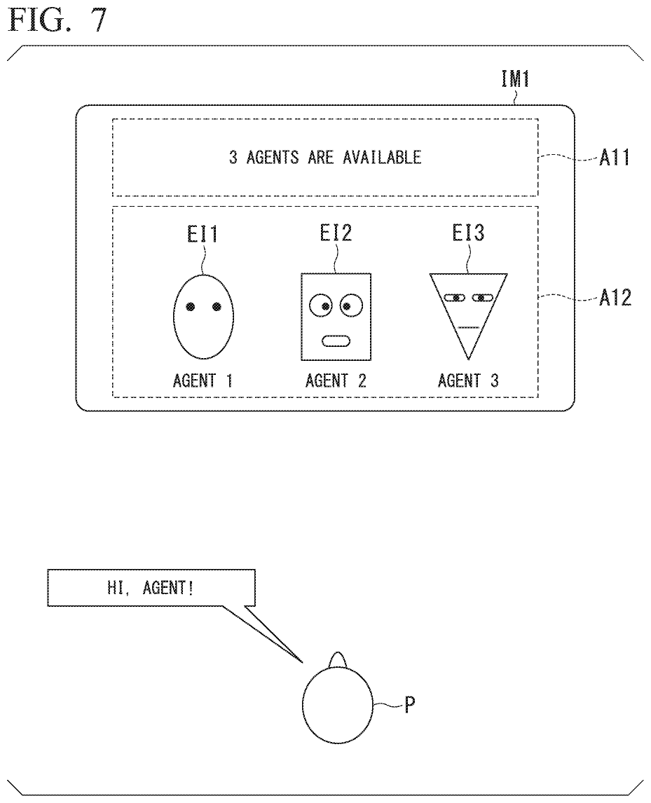

FIG. 7 is a diagram for describing a scene in which the occupant P activates an agent. An image IM1 displayed in a predetermined area of the first display 22 by the display controller 122 is illustrated in the example of FIG. 7. Details, layout, and the like displayed in the image IM1 are not limited thereto. The image IM1 is generated by the display controller 122 on the basis of an instruction from the output controller 120 or the like and displayed in a predetermined area of the first display 22 (an example of a display). The same as the above-described details will be applied to description of images below.

The output controller 120 causes the display controller 122 to generate the image IM1 as an initial state screen and causes the first display 22 to display the generated image IM1, for example, when a specific agent is not activated (in other words, when the first agent functional unit is not specified).

The image IM1 includes, for example, a text information display area A11 and an agent display area A12. For example, information about the number and types of available agents is displayed in the text information display area A11. Available agents are, for example, agents that can be activated by the occupant P. Available agents are set, for example, on the basis of an area and a time period in which the vehicle M is traveling, situations of agents, and the occupant P recognized by the occupant recognition device 80. Situations of agents include, for example, a situation in which the vehicle M is present underground or in a tunnel and thus the agent apparatus 100 cannot communicate with the agent server 200 or a situation in which a process for another request or the like is being executed and thus a process for the next utterance cannot be executed. In the example of FIG. 7, text information of “3 agents are available” is displayed in the text information display area A11.

Agent images associated with available agents are displayed in the agent display area A12. Identification information other than agent images may be displayed in the agent display area A12. In the example of FIG. 7, agent images EI1 to EI3 associated with agents 1 to 3 and identification information (agent 1 to 3) for identifying the respective agents are displayed in the agent display area A12. Accordingly, the occupant P can easily ascertain the number and types of available agents.

Here, it is assumed that the occupant P has uttered “Hi, agent 1!” that is a wake-up word for activating agent 1. In this case, the WU determiner 114 for each agent recognizes the wake-up word included in the speech on which the audio processor 112 has performed audio processing, which is input from the microphone 10 and activates the agent functional unit 150-1 (first agent functional unit) corresponding to the recognized wake-up word. The agent functional unit 150-1 causes the first display 22 to display the agent image EI1 according to control of the display controller 122.

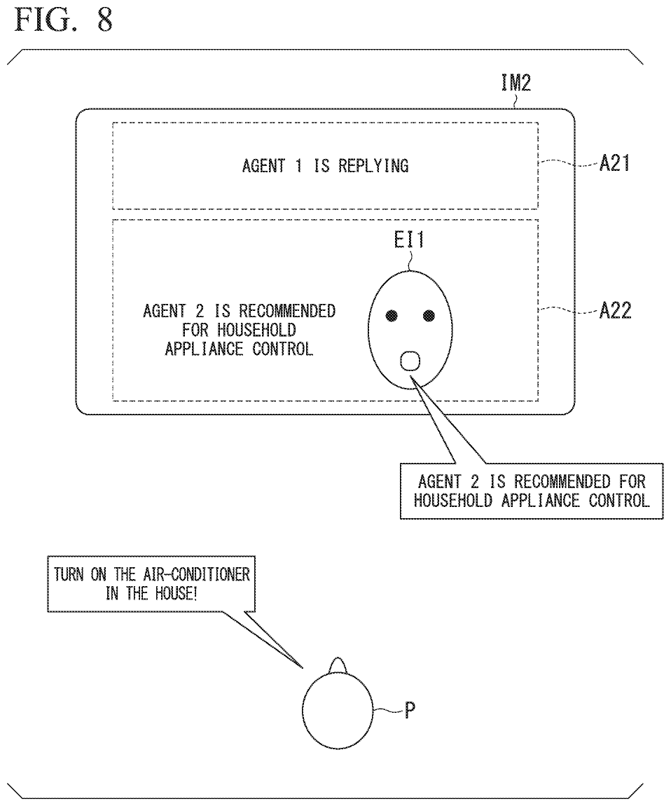

FIG. 8 is a diagram illustrating an example of an image IM2 displayed by the display controller 122 in a scene in which agent 1 is activated. The image IM2 includes, for example, a text information display area A21 and an agent display area A22. For example, information about an agent conversing with the occupant P is displayed in the text information display area A21. In the example of FIG. 8, text information of “Agent 1 is replying” is displayed in the text information display area A21. In this scene, the display controller 122 may not cause the text information to be displayed in the text information display area A21.

An agent image associated with the agent that is replying is displayed in the agent display area A22. In the example of FIG. 8, the agent image EI1 associated with agent 1 is displayed in the agent display area A22. Accordingly, the occupant P can easily ascertain that agent 1 is activated.

Here, it is assumed that the occupant P has uttered “Turn on the air-conditioner in the house!” as illustrated in FIG. 8. The agent functional unit 150-1 transmits the speech (voice stream) on which the audio processor 112 has performed audio processing, which is input from the microphone 10, to the agent server 200-1. The agent server 200-1 performs voice recognition and semantic analysis through the voice recognizer 220 and the natural language processor 222 and acquires a necessary function of “household appliance control.” The agent server 200-1 outputs the acquired necessary function to the agent functional unit 150-1.

The agent functional unit 150-1 acquires function advisability information associated with a function type matching the necessary function and the agent ID thereof with reference to the function advisability information of the function DB 172 using the necessary function output from the agent server 200-1. According to the function advisability information of FIG. 5, agent 1 cannot execute the function of household appliance control. Accordingly, the agent functional unit 150-1 outputs information representing that the agent thereof (agent 1) cannot execute the necessary function (cannot cope with the request of the occupant P) to the agent server 200-1 as a result indicating whether it is possible to cope with the necessary function. When agent 1 can execute the function of household appliance control, the agent functional unit 150-1 outputs information representing that the agent thereof can execute the necessary function (can cope with the request of the occupant P) to the agent server 200-1 as a result indicating whether it is possible to cope with the necessary function.

When the necessary function cannot be executed, the agent functional unit 150-1 may acquire another agent that can execute the necessary function with reference to the function DB 172 and output information about the acquired other agent to the agent server 200-1. For example, according to the function advisability information of FIG. 5, an agent that can execute the function of household appliance control is agent 2. Accordingly, the agent functional unit 150-1 outputs information representing that an agent that can cope with the request of the occupant P is agent 2 to the agent server 200-1 as a result indicating whether it is possible to cope with the necessary function.

The agent server 200-1 generates a response sentence corresponding to the utterance of the occupant P on the basis of the result indicating whether it is possible to cope with the necessary function from the agent functional unit 150-1. Specifically, the agent server 200-1 generates a response sentence for recommending another agent (agent 2) that can cope with the necessary function because agent 1 cannot execute the necessary function. Then, the agent server 200-1 outputs the generated response sentence to the agent functional unit 150-1. The agent functional unit 150-1 causes the output controller 120 to output response details on the basis of the response sentence output from the agent server 200-1.

In the example of FIG. 8, text information of “Agent 2 is recommended for household appliance control” is displayed as response details in the agent display area A22. In this scene, the voice controller 124 generates voice response details given by agent 1 and performs a sound image locating process of locating and outputting the generated voice near the display position of the agent image EI1. In the example of FIG. 8, the voice controller 124 causes the voice of “Agent 2 is recommended for household appliance control” to be output. Accordingly, it is possible to allow the occupant P to easily ascertain that another agent (agent 2) can cope with the request of the occupant P. Therefore, it is possible to provide more appropriate assistance (service) to the occupant P. Although image display and voice output are performed as an output form of response details in the above-described example, the output controller 120 may perform one of image display and voice output. The same applies to description of output forms below.

Agent 1 (the agent functional unit 150-1 and the agent server 200-1) may include, in the response details, information representing that activated agent 1 cannot cope with the request included in the utterance of the occupant P (cannot execute the function with respect to the request) in addition to recommendation of another agent (agent 2) that can cope with the request and output the response details.

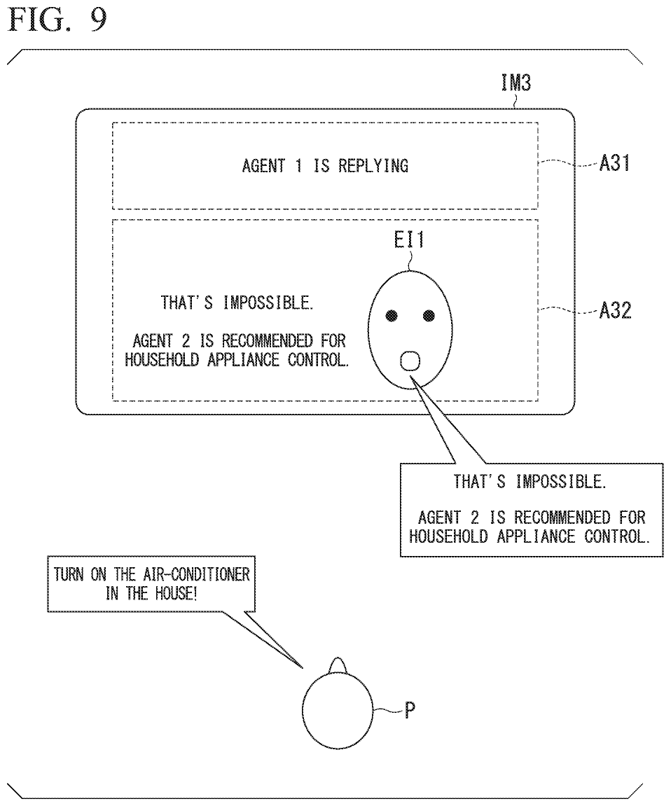

FIG. 9 is a diagram for describing a scene in which response details including information representing that agent 1 cannot cope with the request have been output. In the example of FIG. 9, an image IM3 displayed on the first display 22 according to the display controller 122 is represented. The image IM3 includes, for example, a text information display area A31 and an agent display area A32. Text information the same as that displayed in the text information display area A21 is displayed in the text information display area A31.

The display controller 122 causes response details representing that the activated agent (agent 1) cannot cope with the request in addition to the agent image EI1 the same as that displayed in the agent display area A22 and the text information of “Agent 2 is recommended for household appliance control” to be displayed in the agent display area A32. In the example of FIG. 9, text information of “That's impossible. Agent 2 is recommended for household appliance control” is displayed in the agent display area A32. In the example of FIG. 9, the voice controller 124 causes voice of “That's impossible. Agent 2 recommended for household appliance control” to be output. Accordingly, it is possible to allow the occupant P to easily ascertain that the activated agent cannot cope with the request in addition to that another agent (agent 2) can cope with the request more clearly. Therefore, the occupant P can activate agent 2 instead of agent 1 and cause agent 2 to smoothly execute processing when outputting the same request from next time.

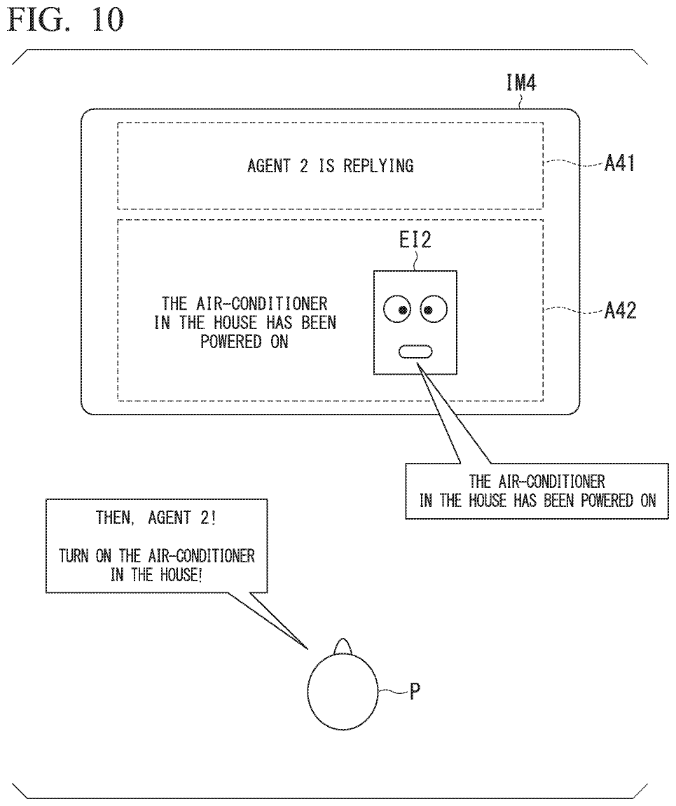

For example, when the occupant P ascertains the above-described response details as illustrated in FIG. 8 or FIG. 9 according to agent 1, the occupant P ends agent 1, activates agent 2 and causes the activated agent 2 to execute a target process. FIG. 10 is a diagram for describing a scene in which agent 2 is activated and caused to execute a process. In the example of FIG. 10, an image IM4 displayed on the first display 22 by the display controller 122 is represented. When the occupant P utters “Then, agent 2, turn on the air-conditioner in the house,” first, the WU determiner 114 for each agent recognizes a wake-up word of agent 2 included in the speech on which the audio processor 112 has performed audio processing, which is input from the microphone 10, and activates the agent functional unit 150-2 corresponding to the recognized wake-up word. The agent functional unit 150-2 causes the first display 22 to display the agent image EI2 according to control of the display controller 122. The agent functional unit 150-2 performs processing such as voice recognition, semantic analysis, and the like of the utterance in cooperation with the agent server 200-2, executes a function corresponding to a request included in the voice and causes the output unit to output response details including an execution result.

In the example of FIG. 10, the image IM4 includes, for example, a text information display area A41 and an agent display area A42. For example, information about an agent conversing with the occupant P is displayed in the text information display area A41. Text information of “Agent 2 is replying” is displayed in the text information display area A41. In this scene, the display controller 122 may not cause the text information to be displayed in the text information display area A41.

The agent image EI2 and response details associated with agent 2 that is replying are displayed in the agent display area A42. In the example of FIG. 10, text information of “The air-conditioner in the house has been powered on” is displayed in the agent display area A42. In this scene, the voice controller 124 generates voice response details given by agent 2 and performs a sound image locating process of locating and outputting the generated voice near the display position of the agent image EI2. In the example of FIG. 10, the voice controller 124 causes the voice of “The air-conditioner in the house has been powered on” to be output. Accordingly, it is possible to allow the occupant P to easily ascertain that control for the request of the occupant P has been executed by agent 2. It is possible to provide more appropriate assistance to the occupant P according to the above-described output form with respect to agents.

### Modified Example

Next, a modified example of the first embodiment will be described. When it is impossible to cope with a request included in speech and the request included in the speech includes a predetermined request, the first agent functional unit activated according to a wake-up word or the like of the occupant P may provide information representing that it is impossible to cope with the request to the occupant P instead of recommending another agent (another agent functional unit) that can cope with the request to the occupant P. The predetermined request is a request for executing a specific function. The specific function is, for example, a function of performing control of the vehicle M such as on-board apparatus control and a function that is likely to directly affect the state of the vehicle M according to the control. The specific function may include a function that is likely to impair the safety of the occupant P, a function of not disclosing specific control details to other agents, and the like.

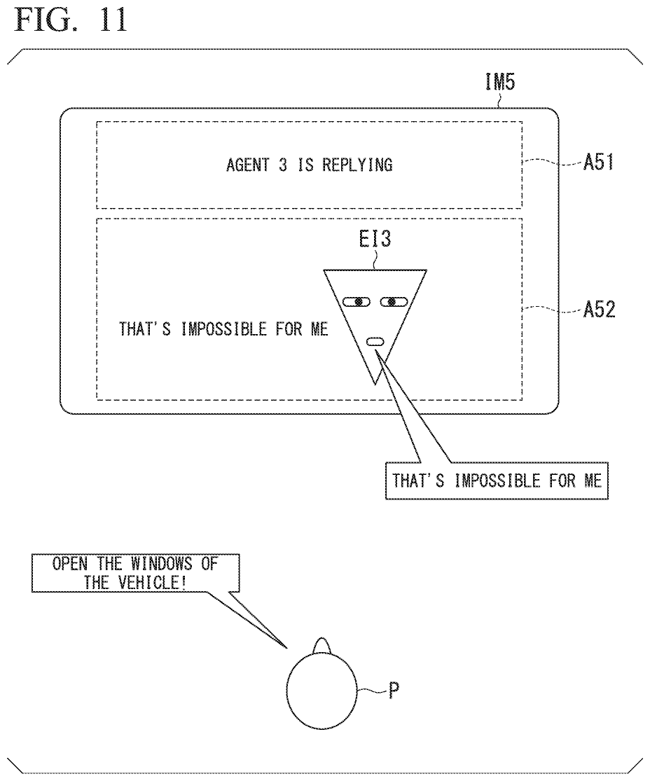

FIG. 11 is a diagram illustrating an example of an image IM5 displayed by the display controller 122 in a scene in which an utterance including a predetermined request is made. It is assumed that agent 3 (agent functional unit 150-3 and the agent server 200-3) is activated and the predetermined request is vehicle apparatus control in the following description. In the scene of FIG. 11, the agent functional unit 150-3 is the first agent functional unit.

The image IM5 includes, for example, a text information display area A51 and an agent display area A52. For example, information about an agent conversing with the occupant P is displayed in the text information display area A51. In the example of FIG. 11, text information of “Agent 3 is replying” is displayed in the text information display area A51. In this scene, the display controller 122 may not cause the text information to be displayed in the text information display area A51.

An agent image associated with the agent that is replying is displayed in the agent display area A52. In the example of FIG. 11, the agent image EI3 associated with agent 3 is displayed in the agent display area A52. Here, it is assumed that the occupant P utters “Open the windows of the vehicle!” as illustrated in FIG. 11. The agent functional unit 150-3 transmits the speech (voice stream) on which the audio processor 112 has performed audio processing, which is input from the microphone 10, to the agent server 200-3. The agent server 200-3 performs voice recognition and semantic analysis through the voice recognizer 220 and the natural language processor 222 and acquires “on-board apparatus control” as a necessary function. This necessary function is a function that cannot be executed by agent 3 and is included in the predetermined request. Accordingly, the agent server 200-3 does not recommend another agent that can cope with the request. In this case, the agent server 200-3 generates, for example, a response sentence representing that the agent thereof cannot cope with the request. Here, the agent server 200-3 has not acquired a result indicating whether another agent can cope with the request, and thus another agent is likely to be able to cope with the request in practice. Accordingly, the agent server 200-3 generates a response sentence for making it clear that the agent thereof cannot cope with the request (another agent is likely to be able to cope with the request). Then, the agent server 200-3 outputs the generated response sentence to the agent functional unit 150-3. The agent functional unit 150-3 causes the output controller 120 to output response details on the basis of the response sentence output from the agent server 200-3.

In the example of FIG. 11, text information of “That's impossible for me” is displayed in the agent display area A52. It is possible to allow the occupant P to easily ascertain that another agent may cope with the request although the corresponding agent cannot cope with the request by including the text “for me.” The voice controller 124 generates voice corresponding to response details and performs a sound image locating process of locating and outputting the generated voice near the display position of the agent image IE3. In the example of FIG. 11, the voice controller 124 causes the voice of “That's impossible for me” to be output. It is possible to allow the occupant P to easily ascertain that another agent may cope with the request although the corresponding agent cannot cope with the request by providing a response result including information such as “for me.”

Although the first agent functional unit determines whether a necessary function included in an utterance of the occupant P is executable using the function DB 172 in the above-described first embodiment, the first agent functional unit may determine whether it is executable according to whether the agent thereof is in a situation in which it cannot execute the necessary function (situation in which it cannot cope with the request) instead of using the function DB 172. Cases in which the agent is in a situation in which it cannot execute the necessary function include, for example, a case in which the agent thereof is already executing another function and it is inferred that a predetermined time or longer will be taken to end execution, and a case in which it is clearly inferred that another agent can appropriately cope with the request. Accordingly, even when an activated agent is in a situation in which it cannot cope with the request, it is possible to recommend another agent that can cope with the request. As a result, it is possible to provide more appropriate assistance to the occupant P.

### [Processing Flow]

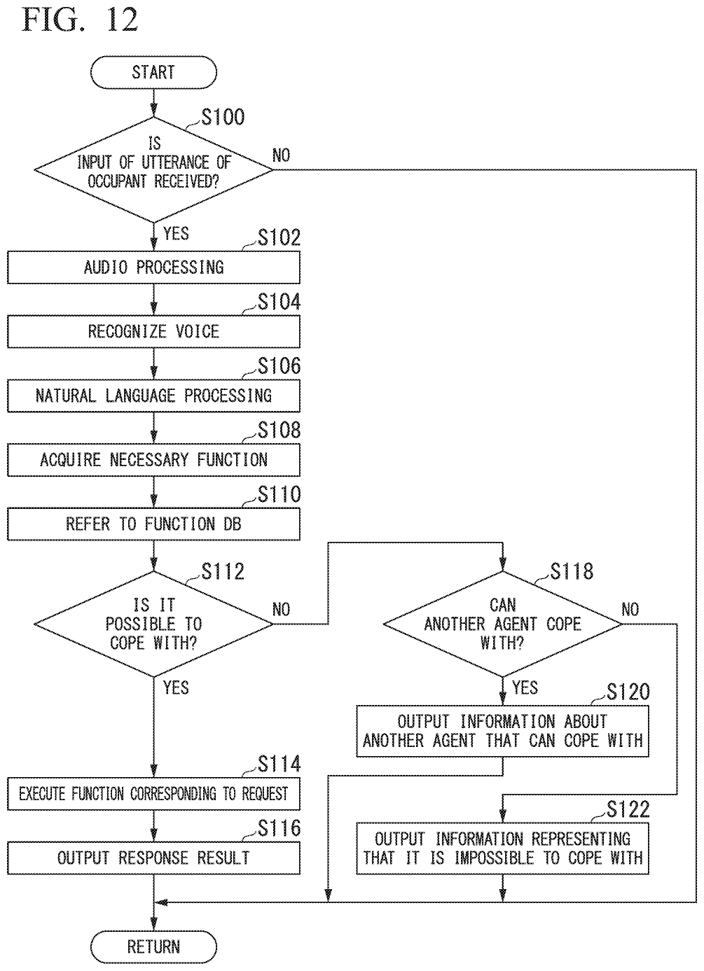

FIG. 12 is a flowchart illustrating an example of a processing flow executed by the agent apparatus 100 of the first embodiment. Processes of this flowchart may be repeatedly executed at a predetermined interval or predetermined timing, for example. Hereinafter, it is assumed that the first agent functional unit is activated according to an utterance of a wake-up word, or the like of the occupant P. Processing of an agent realized by the first agent functional unit 150 and the agent server 200 in cooperation will be described below.

First, the audio processor 112 of the agent apparatus 100 determines whether input of an utterance of the occupant P is received from the microphone 10 (step S100). When it is determined that input of the utterance of the occupant P is received, the audio processor 112 performs audio processing on the speech of the occupant P (step S102). Then, the voice recognizer 220 of the agent server 200 recognizes the voice (voice stream) on which audio processing has been performed, input from the agent functional unit 150, and converts the voice into text (step S104). Then, the natural language processor 222 executes natural language processing on text information obtained from the text and performs semantic analysis of the text information (step S106).

Then, the natural language processor 222 acquires a function necessary for a request included in the utterance of the occupant P (necessary information) on the basis of a semantic analysis result (step S108). Subsequently, the agent functional unit 150 refers to the function DB 172 (step S110) and determines whether the agent thereof (the first agent functional unit) can cope with the request including the necessary function (whether a process corresponding to the necessary function is executable) (step S112). When it is determined that the agent can cope with the request, the agent functional unit 150 executes the function corresponding to the request (step S114) and causes the output unit to output a response result including an execution result (step S116).

When it is determined that the agent cannot cope with the request in the process of step S112, the agent functional unit 150 determines whether another agent (another agent functional unit) can cope with the necessary function (step S118). When it is determined that another agent can cope with the necessary function, the agent functional unit 150 causes the output unit to output information about another agent that can cope with the necessary function (step S120). In the process of step S120, the agent functional unit 150 may cause information representing that the agent thereof cannot cope with the necessary function to be output in addition to the information about another agent. When it is determined that another agent cannot cope with the necessary function in the process of step S118, the agent functional unit 150 cause the output unit to output information representing that another agent cannot cope with the necessary function (step S122). Accordingly, the processes of this flowchart end. When input of an utterance of the occupant P is not received in step S100, the processes of this flowchart end. When input of an utterance of the occupant P is not received even after the lapse of predetermined time from activation of the first agent functional unit, the agent apparatus may perform a process of ending an activated agent.

According to the above-described agent apparatus 100 of the first embodiment, it is possible to provide more appropriate assistance (service) to the occupant P by including a first acquirer (the microphone 10 and the audio processor 112) which acquires voice of the occupant P of the vehicle M, a recognizer (the voice recognizer 220 and the natural language processor 222) which recognizes voice acquired by the first acquirer, and a plurality of agent functional units 150 which provide services including responses using voice on the basis of a recognition result of the recognizer and recommending another agent functional unit to the occupant P when the first agent functional unit included in the plurality of agent functional units cannot respond to the recognition result of the recognizer and another agent of the plurality of agent functional units can cope with the recognition result.

### Second Embodiment

Hereinafter, a second embodiment will be described. An agent apparatus of the second embodiment differs from the agent apparatus 100 of the first embodiment in that, when it is impossible to cope with a request of the occupant P, another agent functional unit is inquired about whether it can cope with the request and information about another agent that can cope with the request is acquired on the basis of the inquiry result. Accordingly, the aforementioned difference will be mainly described below. In the following description, the same components as those of the above-described first embodiment are represented by the same names or same signs and detailed description thereof is omitted here.

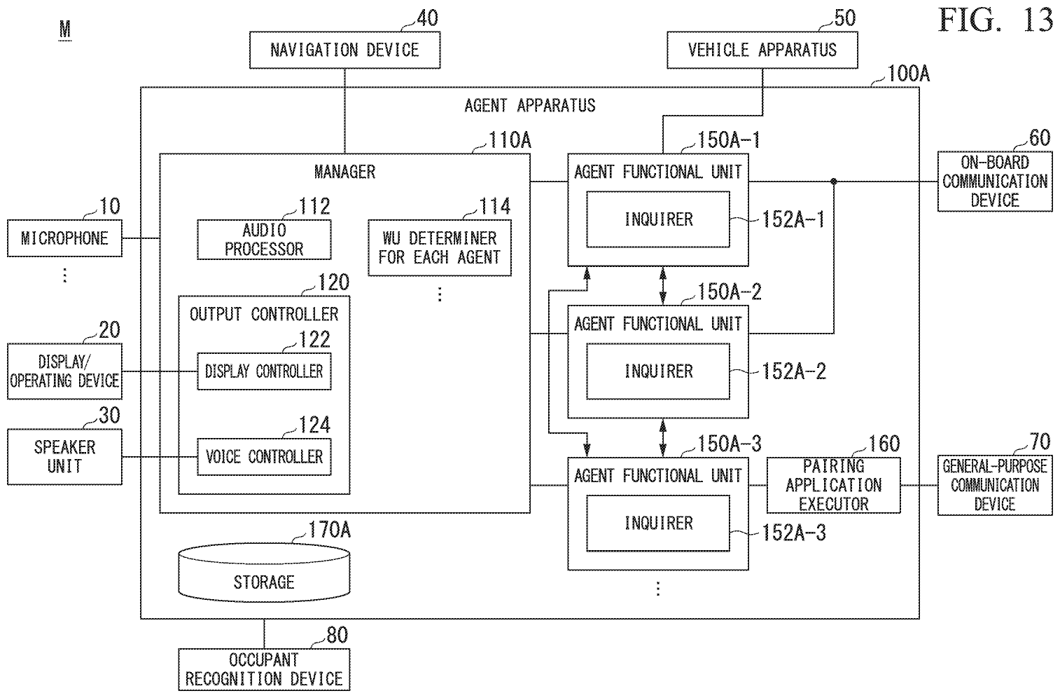

FIG. 13 is a diagram illustrating a configuration of an agent apparatus 100A according to the second embodiment and apparatuses mounted in the vehicle M. For example, one or more microphones 10, a display/operating device 20, a speaker unit 30, a navigation device 40, a vehicle apparatus 50, an on-board communication device 60, an occupant recognition device 80, and the agent apparatus 100A are mounted in the vehicle M. There are cases in which a general-purpose communication device 70 is included in a vehicle cabin and used as a communication device.

The agent apparatus 100A includes a manager 110A, agent functional units 150A-1, 150A-2 and 150A-3, a pairing application executer 160, and a storage 170A. The manager 110A includes, for example, an audio processor 112, a WU determiner 114 for each agent, and an output controller 120. The agent functional units 150A-1 to 150A-3 respectively include inquirers 152A-1 to 152A-3, for example. Components of the agent apparatus 100A are realized, for example, by a hardware processor such as a CPU executing a program (software). Some or all components may be realized by hardware (a circuit including circuitry) such as an LSI circuit, an ASIC, an FPGA or a GPU or realized by software and hardware in cooperation. The program may be stored in advance in a storage device (storage device including a non-transitory storage medium) such as an HDD or a flash memory or stored in a separable storage medium (non-transitory storage medium) such as a DVD or a CD-ROM and installed when the storage medium is inserted into a drive device. The inquirer 152A in the second embodiment is an example of a “second acquirer.”

The storage 170A is realized by the above-described various storage devices. The storage 170A stores, for example, various data and programs.

Hereinafter, the agent functional unit 150A-1 from among the agent functional units 150A-1 to 150A-3 is described as a first agent functional unit. The agent functional unit 150A-1 compares a necessary function from the agent server 200-1 with a function of a predetermined agent thereof and determines whether it can cope with a request (execute the necessary function). The function of the agent of the agent functional unit 150A-1 may be stored in a memory of the agent functional unit 150A-1 or stored in the storage 170A in a state in which other agent functional units cannot refer to the function. Then, when it is determined that it is impossible to cope with the request (it is impossible to execute a function corresponding to the necessary function), the inquirer 152A-1 inquire of other agent functional units 150A-2 and 150A-3 about whether they can cope with to the request (execute the necessary function).

The inquirers 152A-2 and 152A-3 of other agent functional units 150A-2 and 150A-3 compare the necessary function with functions of agents thereof on the basis of the inquiry about whether it is possible to cope with the request from the inquirer 152A-1 and output results indicating whether it is possible to cope with the request to the inquirer 152A-1. The results indicating whether it is possible to cope with the request are an example of “function information.”

The inquirer 152A-1 outputs the results indicating whether it is possible to cope with the request from the inquirers 152A-2 and 152A-3 to the agent server 200-1. Then, the agent server 200-1 generates a response sentence on the basis of the results indicating whether it is possible to cope with the request output from the agent functional unit 150A-1.

### [Processing Flow]

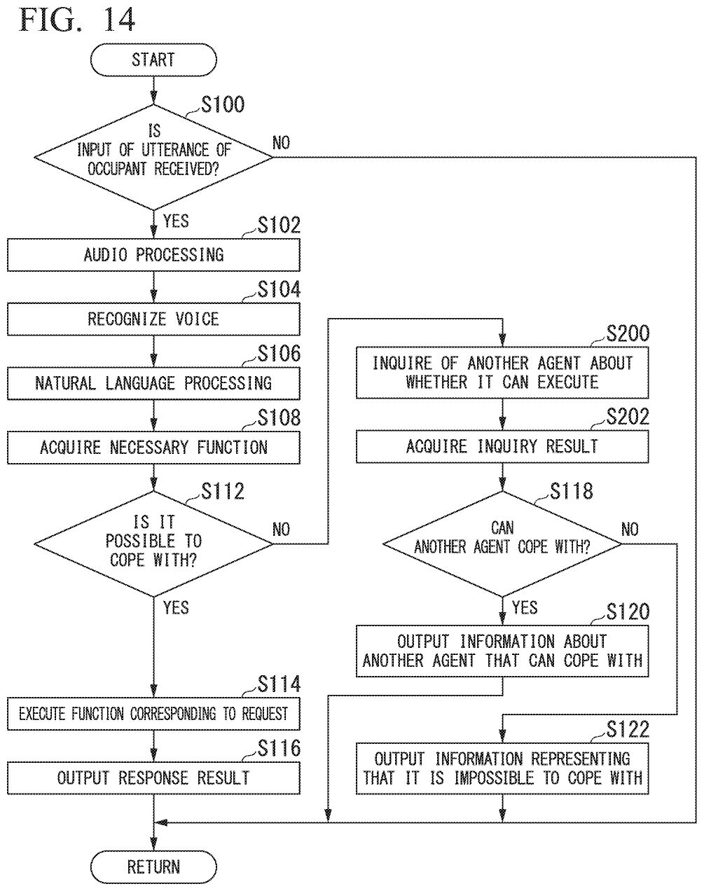

FIG. 14 is a flowchart illustrating an example of a processing flow executed by the agent apparatus 100A of the second embodiment. The flowchart illustrated in FIG. 14 differs from the flowchart in the above-described first embodiment illustrated in FIG. 12 in that processes of steps S200 and S202 are added. Accordingly, the processes of steps S200 and S202 will be mainly described below. The following description is based on the assumption that the first agent functional unit is the agent functional unit 150A-1.

In the process of step S112 of the second embodiment, the agent functional unit 150A-1 compares a necessary function with the function of the predetermined agent thereof and determines whether it can cope with a request. Here, when the agent of the agent functional unit 150A-1 can cope with the request, the processes of steps S114 and S116 are performed. When the agent of the agent functional unit 150A-1 cannot cope with the request, the inquirer 152A-1 of the agent functional unit 150A-1 inquires of other agent functional units 150A-2 and 150A-3 about whether they can cope with the request (step S200). Then, the inquirer 152A-1 acquires inquiry results (results indicating whether it is possible to cope with the request, function information) from other inquirers 152A-2 and 152A-3 (step S202) and executes the processes of steps S118 to S122 on the basis of the acquired results.

Although the agent functional unit 150A-1 inquires of other agent functional units 150A-2 and 150A-3 about whether they can cope with the request in description of the above-described second embodiment, the agent server 200-1 may inquire of other agent servers 200-2 and 200-3 about whether they can cope with the request.

According to the above-described agent apparatus 100A of the second embodiment, it is possible to cause the output unit to output a response result including whether other agents can cope with a request even when the function DB 172 is not present as well as obtaining the same effects as those of the agent apparatus 100 of the first embodiment. It is possible to acquire results indicating whether it is possible to cope with a request, which have been obtained from comparison with information representing whether it is possible to cope with the request updated by other agents in real time.

The above-described first embodiment and second embodiment may be combinations of some or all of other embodiments. Some of all functions of the agent apparatus 100 (100A) may be included in the agent server 200. Some or all functions of the agent server 200 may be included in the agent apparatus 100 (100A). That is, separation of functions in the agent apparatus 100 (100A) and the agent server 200 may be appropriately changed according to components of each apparatus, the sales of the agent server 200 and the agent system 1, and the like. Separation of functions in the agent apparatus 100 (100A) and the agent server 200 may be set for each vehicle M.

Although the vehicle M is used as an example of a moving body in the above-described embodiments, other moving bodies such as a ship, a flying object, and the like may be used, for example. Although the occupant P of the vehicle M is used as an example of a user in the above-described embodiments, a user who uses functions of agents in a state in which the user is not riding in the vehicle M may be included. In this case, users include, for example, a user who executes functions of the general-purpose communication device 70 and agents, a user who is present near the vehicle M (specifically, at a position at which speech can be collected through the microphone 10) and executes functions of agents outside the vehicle, and the like. Moving bodies may include a portable mobile terminal.

While forms for carrying out the present invention have been described using the embodiments, the present invention is not limited to these embodiments at all, and various modifications and substitutions can be made without departing from the gist of the present invention.

What is claimed is:

1. An agent apparatus comprising:
a first acquirer configured to acquire voice of a user;
a recognizer configured to recognize the voice acquired by the first acquirer; and
a plurality of agent functional units, each of the agent functional unit being configured to provide a service including causing an output unit to output a response on the basis of a recognition result of the recognizer,
wherein, when a first agent functional unit included in the plurality of agent functional units is not able to cope with a request included in the voice recognized by the recognizer and another agent functional unit of the plurality of agent functional units is able to cope with the request, the first agent functional unit causes the output unit to output information for recommending the other agent functional unit to the user.

2. The agent apparatus according to claim 1,
wherein, when the first agent functional unit is not able to cope with the request and the other is able to cope with the request, the first agent functional unit provides information representing that the first agent functional unit is not able to cope with the request to the user and causes the output unit to output the information for recommending the other agent functional unit to the user.

3. The agent apparatus according to claim 1,
further comprising a second acquirer configured to acquire function information of each of the plurality of agent functional unit,
wherein the first agent functional unit acquires information on another agent functional unit which is able to cope with the request on the basis of the function information acquired by the second acquirer.

4. The agent apparatus according to claim 1,
wherein, when the first agent functional unit is not able to cope with the request and the request includes a predetermined request, the first agent functional unit does not cause the output unit to output the information for recommending the other agent functional unit to the user.

5. The agent apparatus according to claim 4,
wherein the predetermined request includes a request for causing the first agent functional unit to execute a specific function.

6. The agent apparatus according to claim 5,
wherein the specific function includes a function of controlling a moving body in which the plurality of agent functional units are mounted.

7. An agent apparatus control method, using a computer, comprising:
activating a plurality of agent functional units;
recognizing acquired voice of a user and providing services including causing an output unit to output a response on the basis of a recognition result as functions of the activated agent functional units; and
when a first agent functional unit included in the plurality of agent functional units is not able to cope with a request included in the recognized voice and another agent functional unit of the plurality of agent functional units is able to cope with the request, causing the output unit to output information for recommending the other agent functional unit to the user.

8. A computer-readable non-transitory storage medium storing a program causing a computer to:
activate a plurality of agent functional units;
recognize acquired voice of a user and provide services including causing an output unit to output a response on the basis of a recognition result as functions of the activated agent functional units; and
when a first agent functional unit included in the plurality of agent functional units is not able to cope with a request included in the recognized voice and another agent functional unit of the plurality of agent functional units is able to cope with the request, cause the output unit to output information for recommending the other agent functional unit to the user.
